(19) United States
(12) Patent Application Publication
(10) Pub. No.: US 2026/0288596 A1
(43) Pub. Date: Sep. 24, 2026

(54) SMART-BACKUP SYSTEM FOR A COLLABORATIVE CONTENT-MANAGEMENT PLATFORM

(71) Applicant: Druva Inc., Santa Clara, CA (US)

(72) Inventors: Babasaheb Ghaytadkar, Pune (IN); Prahlad Nishal, Gurgaon (IN)

(73) Assignee: Druva Inc., Santa Clara, CA (US)

(21) Appl. No.: 19/558,012

(22) Filed: Mar. 5, 2026

(30) Foreign Application Priority Data
Mar. 21, 2025 (IN) 202541025840

(51) Int. Cl. G06F 11/1446

(52) U.S. Cl. CPC G06F 11/1451; G06F 2201/84

(57) ABSTRACT

The invention provides a smart-backup system for a collaborative content-management platform. The system includes a memory storing one or more processor-executable routines and a processor communicatively coupled to the memory. The processor is configured to execute one or more processor-executable routines to retrieve properties corresponding to the content-management platform. The platform includes one or more associated subsites and cloud-containers, each of the cloud-containers having folders and associated files. The processor is further configured to list each of the one or more associated subsites and cloud-containers using a recursive traversal routine. The processor is further configured to sort each of the listed subsites and cloud-containers based on a last modified time. The processor is further configured to perform an incremental backup of the platform based upon the last modified time.

### PRIORITY STATEMENT

The present application claims priority under 35 U.S.C. § 119 to Indian patent application number 202541025840 filed 21 Mar. 2025, the entire contents of which are hereby incorporated herein by reference.

### FIELD OF INVENTION

Embodiments of the present disclosure relate to data backup and recovery system, and more particularly, to a smart-backup system for a collaborative cloud-based content management platform.

### BACKGROUND

With the widespread adoption of cloud-based content management platforms, organizations increasingly rely on collaborative environments to store, manage, and share data across multiple subsites, folders, and cloud-containers. Backing up the data in a collaborative content-management platform is a critical requirement for organizations to ensure data integrity, security, and compliance.

A comprehensive backup includes not only documents but also site settings, access control lists (ACLs), and document libraries along with metadata. Platforms such as Microsoft provides Representational State Transfer (REST) and Graph APIs to facilitate backups. However, these APIs utilize throttling algorithms that limit the number of requests within a given timeframe. This restriction poses a significant challenge in achieving backup Service Level Agreements (SLAs), as excessive API calls can lead to delays and incomplete backups.

Traditional backup approaches often involve scanning entire sites and document libraries of the collaborative platforms without optimizing API usage, resulting in inefficient resource utilization, increased API throttling, and longer backup times.

Thus, there is a need for an efficient backup mechanism that reduces API calls while accurately identifying and capturing changes in cloud-containers. Such a system may facilitate resource utilization, remain within API limits, and ensure timely and reliable backups of the collaborative content-management platform.

### BRIEF DESCRIPTION

The following description is illustrative only and is not intended to be in any way limiting. In addition to the illustrative aspects, example embodiments, and features described, further aspects, example embodiments, and features will become apparent by reference to the drawings and the following detailed description.

Briefly, according to the example embodiments, a smart-backup system for a collaborative content-management platform is provided. The system includes a memory storing one or more processor-executable routines and a processor communicatively coupled to the memory. The processor is configured to execute one or more processor-executable routines to retrieve properties corresponding to the content-management platform. The platform includes one or more associated subsites and cloud-containers, each of the cloud-containers having folders and associated files. The processor is further configured to list each of the one or more associated subsites and cloud-containers using a recursive traversal routine. The processor is further configured to sort each of the listed subsites and cloud-containers based on a last modified time. The processor is further configured to perform an incremental backup of the platform based upon the last modified time.

According to another example embodiment, a smart-backup system for a collaborative content-management platform is provided. The system includes a memory storing one or more processor-executable routines and a processor communicatively coupled to the memory. The processor is configured to execute one or more processor-executable routines to access one or more associated subsites and cloud-containers of the platform to retrieve associated properties of each of the associated subsites and cloud-containers. The processor is further configured to list each of the one or more associated subsites and cloud-containers using depth-first search (DFS). The processor is further configured to compare a last modified time of the listed subsites and cloud-containers with the respective previous backup time to identify modified subsites. The processor is further configured to determine one or more modified cloud-containers using change token APIs. The processor is further configured to initiate backup of the one or more modified cloud-containers.

According to another example embodiment, a method of performing a backup of a content-management platform is provided. The method includes receiving a backup request for the content-management platform. The method further includes retrieving properties corresponding to one or more associated subsites and cloud-containers of the platform. The method further includes listing each of the one or more associated subsites and cloud-containers using a recursive traversal routine. The method further includes sorting each of the listed subsites and cloud-containers based on a last modified time. The method further includes performing an incremental backup of the platform based upon the last modified time.

### BRIEF DESCRIPTION OF THE DRAWINGS

The disclosure will be described and explained with additional specificity and detail with the accompanying figures in which:

FIG. 1 is a block diagram representation of components of a smart-backup system for a collaborative content-management platform, according to some aspects of the present description;

FIG. 2 is a representation of an example structure of the collaborative content-management platform of FIG. 1, according to some aspects of present description;

FIG. 3 is a flowchart illustrating process for performing smart-backup in a collaborative content-management platform using the system of FIG. 1; and

FIG. 4 is a block diagram of an embodiment of a computing device in which the smart-backup system for a collaborative content-management platform, described herein, is implemented.

### DETAILED DESCRIPTION

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed but may also have additional steps not included in the figures. It should also be noted that in some alternative implementations, the functions/acts/steps noted may occur out of the order noted in the figures. For example, two figures shown in succession may be executed substantially concurrently or may sometimes be executed in the reverse order, depending upon the functionality/acts involved.

Further, although the terms first, second, etc. may be used herein to describe various elements, components, regions, layers, and/or sections, it should be understood that these elements, components, regions, layers, and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between the first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Embodiments of the present invention provide a smart-backup system for a collaborative content-management platform that ensures efficient, optimized, and reliable data backup. The embodiments of the present disclosure reduce resource consumption and redundant data storage, along with inefficient API usage. The system utilizes incremental backup techniques along with a recursive traversal routine, and change token APIs to minimize storage usage and API calls while maintaining Service Level Agreements (SLAs) for backup processes. This results in a scalable, automated, and resource-efficient backup solution that enhances performance, reliability, and adaptability for organizations relying on cloud-based content management platforms.

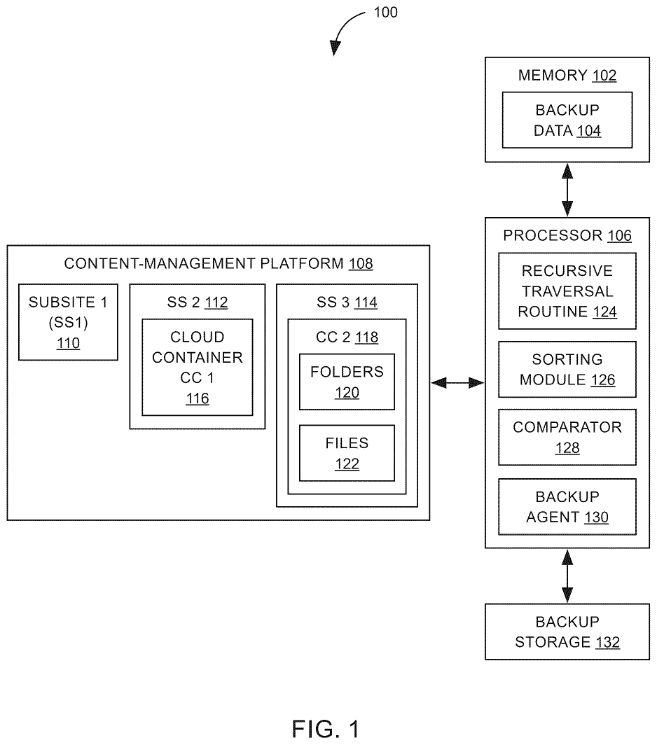

FIG. 1 is a block diagram 100 illustrating components of a smart-backup system for a collaborative content-management platform 108 to implement some embodiments of the invention. The system 100 includes a memory 102, a processor 106 and the content-management platform 108. The memory 102 is configured to store one or more processable routines. The processor 106 is communicatively coupled to the memory 102 and is configured to execute one or more processor-executable routines to access, identify and perform an incremental backup of datasets stored on the collaborative content-management platform 108.

The processor 106 is configured to access and retrieve metadata associated with the content-management platform 108. The platform 108 includes one or more sites and associated subsites (represented by reference numerals 110, 112, and 114) and cloud-containers (represented by reference numerals 116 and 118), each structured to store relevant digital content. The cloud-containers (represented by reference numerals 116 and 118) are configured to serve as storage units that include one or more folders 120 and their associated files 122 to enable users to organize and manage content. The collaborative content-management platform 108 includes one or more platforms such as a cloud-based platform.

The system 100 is configured to access the platform 108 having one or more associated subsites such as 110, 112, and 114 and cloud-containers 116 and 118 to extract key properties such as metadata, access permissions, version history, and last modified timestamps of the subsites and/or cloud-containers.

The processor 106 is further configured to implement a recursive traversal routine 124, such as depth-first search (DFS) to systematically list all associated subsites 110, 112, and 114 and cloud-containers 116 and 118 to provide a comprehensive data indexing. The processor 106 is further configured to organise and prioritise the listed subsites 110 and cloud-containers 116 using a sorting module 126 for backup execution. The sorting module 126 is configured to sort and categorise the listed subsites 110 and cloud-containers 116 of the platform 108 based on their last modified time. Other parameters for sorting and categorising the subsites may be used.

The processor 106 is configured to identify the modified cloud-containers 116 based on their last modified time. Once the modified cloud-container 116 is identified, the processor 106 is configured to compare its last modified time with the corresponding previous backup time using a comparator 128 to determine whether an incremental backup is required. This ensures that the updated content is backed up, reducing redundant storage operations and optimizing system performance.

Moreover, the processor 106 is further configured to utilize change token APIs to identify one or more modified cloud-containers 116 for backup. The change token APIs generates unique tokens whenever a change is detected in the cloud-container 116. The comparator 128 is configured to compare these tokens with the ones stored from the previous backup cycle. If the new token is detected, it confirms that changes have occurred within the respective cloud-container 116, prompting the system 100 to include it in the incremental backup process. Once identified, the processor 106 is configured to initiate the backup of both content and associated settings within the modified cloud-containers 116 using a backup agent 130, ensuring that configurations and metadata are stored alongside the stored data. The backup agent 130 is further configured to commit a backup snapshot for the backed-up cloud-containers 116.

Additionally, the processor 106 is configured to acquire the latest change token, for cloud-containers 116 that remain unchanged since the last backup cycle. These change tokens serve as markers that help track modifications over time. The processor 106 is configured to checkpoint the acquired change tokens and store them for subsequent backup cycles. This technique may reduce unnecessary scanning and processing of unchanged data, thereby enhancing backup efficiency and reducing computational overhead.

The memory 102 is configured to store the properties of platform 108, that includes details of subsites 110 and cloud-containers 116, last modified timestamps, change token API records, and backup data 104, among others. Additionally, memory 102 is configured to store the checkpointed change tokens, facilitating optimized backup cycles while minimizing redundant data transfers. By maintaining structured records of content modifications and reconciliation parameters of backup data 104, the memory 102 ensures a seamless and intelligent backup process, enhancing data reliability and recovery efficiency within the collaborative platform 108.

The system 100 further includes a backup storage 132 to store snapshots of incremental backups, preserving content, configurations, and metadata for seamless recovery. Additionally, the backup storage system 132 is configured to support reconciliation processes, ensuring that backup policies align with business requirements while maintaining data integrity and accessibility.

In some examples, the processor 106 is configured to determine if the platform 106 is due for reconciliation based on a configurable reconciliation period. If it is detected that a reconciliation is required, the backup agent 130 is configured to perform the incremental backup for all associated cloud-containers (such as represented by 116 and 118) and subsites (such as represented by 110, 112, and 114), ensuring that the latest modifications are captured. If it is detected that the reconciliation is not due, the backup agent 130 is configured to commit the backup snapshot, preserving the current backup state without unnecessary data duplication.

The reconciliation period is user-configurable and can be defined based on factors such as a waiting period or changes in access control lists (ACLs). Additionally, the system 100 includes a global reconciliation period, which mandates the backup of all cloud-based containers (represented by 116 and 118) at predefined intervals, ensuring data consistency and comprehensive protection.

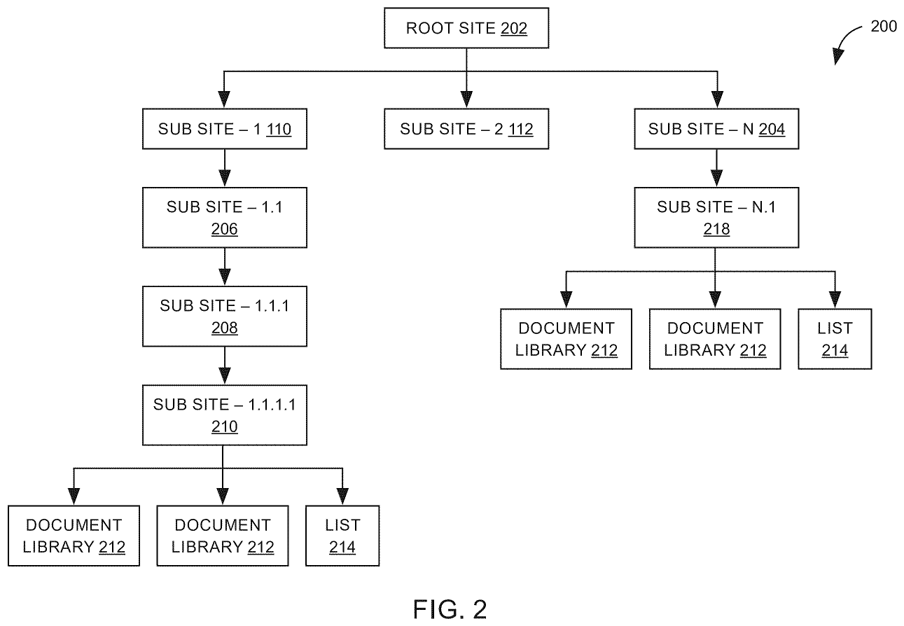

FIG. 2 illustrates an example hierarchical structure 200 of a cloud container such as 116 of the collaborative content-management platform 108 of FIG. 1. As discussed before, the collaborative content management platform 108 is a digital system that enables users to create, store, organize, and manage documents, media, and structured data efficiently. It facilitates collaboration, version control, access management, and seamless integration with cloud storage for enhanced scalability and security.

As describe above, the collaborative content-management platform 108 includes one or more platforms such as the cloud-based platform. The platform 108 includes one or more associated subsites (represented by reference numerals 110, 112, and 204) and cloud-containers (reference numerals represented by 116 and 118), each structured to store relevant digital content. The cloud-containers 116 and 118 are configured to serve as storage units that includes a plurality of folders 120 and their associated files 122 to enable users to organize and manage content efficiently.

The platform 108 includes a root site 202 configured to serve as a container that manages global settings, permissions, and configurations. The root site 202 may include a plurality of subsites such as SS1, SS2, ...., SSn, (generally represented by reference numerals 110, 112, 204), each subsite configures to function as an independent module with its own data storage elements.

In addition, each subsite such as 110 includes one or more subsites (generally represented by reference numerals 206, 208, 210, and 218), that includes document libraries 212 configured to store various file types such as PDFs, word documents, and spreadsheets, supporting features like versioning, metadata tagging, and access control. Additionally, each subsite (represented by 206, 208, 210, and 218), includes lists 214 that provide structured data storage for tasks, records, and events, facilitating easy sorting and filtering. To ensure scalability and security, the cloud containers (116 and 118) act as external storage, handling backups and archiving critical data. This structure 200 of the platform 108 facilitates data segmentation, supports seamless scalability, and integrates cloud-based storage for remote accessibility and disaster recovery.

The processor 106 is configured to extract one or more properties of each site or subsite, such as metadata, access permissions, version history, and last modified timestamps. The processor 106 is further configured to implement the recursive traversal routine 124, to systematically list all associated subsites 110, 112, and 114 and cloud-containers 116 and 118. The processor 106 is further configured to organise and prioritise the listed subsites 110 and cloud-containers 116 using the sorting module 126 based on their last modified time. The modified cloud-containers 116 are identified based on their last modified time.

In some embodiments, the processor 106 is configured to utilize change token APIs to identify one or more modified cloud-containers 116 for backup. Once identified, the processor 106 is configured to initiate the incremental backup of both content and associated settings within the modified cloud-containers 116 using the backup agent 130. The backup agent 130 is further configured to commit a backup snapshot for the backed-up cloud-containers 116.

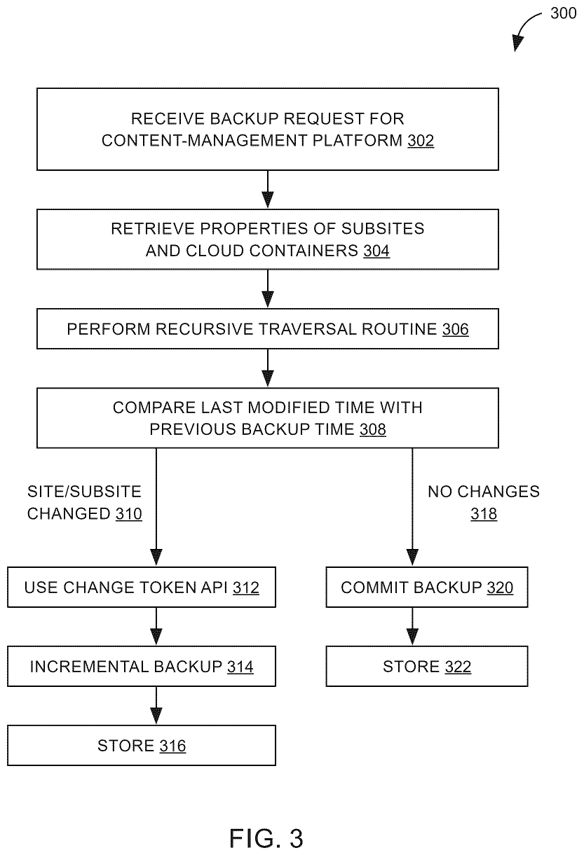

FIG. 3 is a flowchart 300 illustrating the process of implementing the smart-backup system for the collaborative content-management platform using the system 100 of FIG. 1. At block 302, the system receives a backup request for the content-management platform. At 304, the properties associated with the content-management platform are retrieved. Here, properties associated with each of the one or more associated subsites and cloud-containers for the site are accessed and stored. The system then lists all the subsites and cloud-container within the platform by utilizing a recursive traversal routine (block 306). In one example, depth-first search (DFS) is utilized for listing the sub-sites and the cloud containers. However, other recursive traversal routine techniques may be envisaged.

Moreover, the listed subsites and cloud-containers are sorted based on their last modified timestamps. At block 308, last modified timestamps are compared relative to the previous backup time. If it is detected that the subsite or cloud-container has changed (block 310), the system initiates the change token API (block 312) to identify the modified containers. At block 314, the modified containers are backed up in the incremental backup process. In addition, once the modified containers are identified, the backup of both content and associated settings within the modified cloud-containers is initiated, ensuring that configurations and metadata are preserved alongside the stored data. The system stores this information in the backup storage system (block 316).

Conversely, if no changes 318 are detected, the backup process proceeds with a commit operation (block 320) while storing relevant metadata, such as timestamps, change token API data, and results of previous backup scans (block 322). Additionally, the system persistently stores parameters corresponding to the listed subsites and cloud-containers to enhance backup efficiency in subsequent operations.

To ensure continued synchronization, the system may repeat the recursive traversal routine periodically for each subsite and cloud-container, allowing the backup system to adapt dynamically to platform modifications. This approach enables a streamlined, efficient, and intelligent backup process that minimizes storage requirements while maintaining up-to-date content backups.

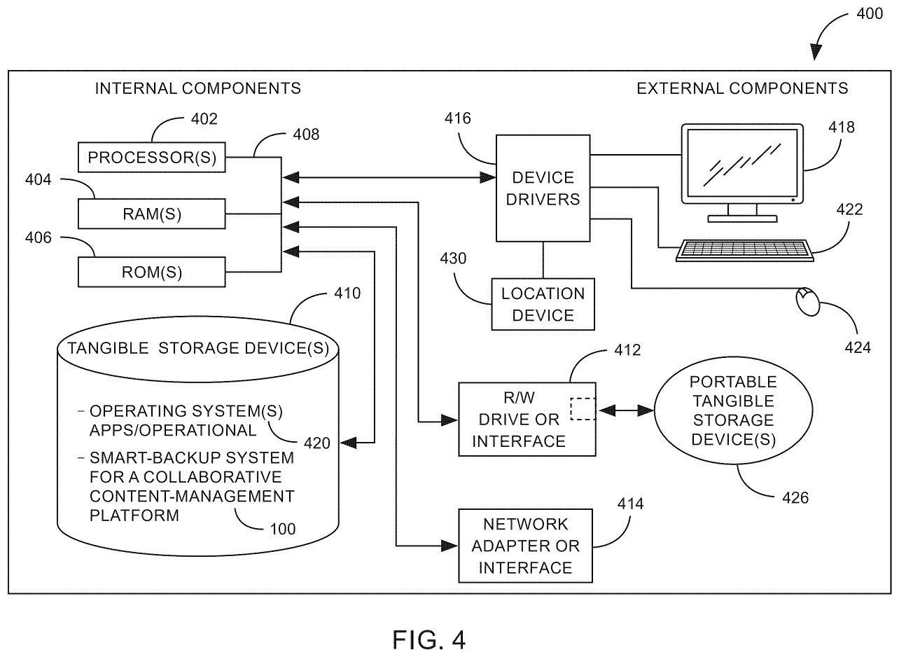

The modules of the smart-backup system 100 for a collaborative content-management platform, described herein, are implemented in computing devices to facilitate user assistance and task execution. One example of a computing device 400 is described below in FIG. 4. The computing device 400 includes one or more processor(s) 402, one or more computer-readable RAMs 404, and one or more computer-readable ROMs 406 on one or more buses 408. Further, the computing device 400 includes a tangible storage device 410 that may be used to execute operating systems 420 and the smart-backup system 100 for a collaborative content-management platform. The various modules of the smart-backup system 100 for a collaborative content-management platform may be stored in the tangible storage device 410. Both, the operating systems 420 and the smart-backup system 100 for a collaborative content-management platform are executed by one or more processor(s) 402 via one or more respective RAMs 404 (which typically include cache memory). The execution of the operating systems 420 and/or the smart-backup system 100 for a collaborative content-management platform by the one or more processor(s) 402, configures the one or more processor(s) 402 as a special purpose processor configured to carry out the functionalities of the operation systems 420 and/or the smart-backup system 100 for a collaborative content-management platform as described above.

Examples of tangible storage devices 410 include semiconductor storage devices such as ROM, EPROM, flash memory, or any other computer-readable tangible storage device that may store a computer program and digital information.

The computing device 400 also includes an R/W drive or interface 414 to read from and write to one or more portable computer-readable tangible storage devices 428 such as a CD-ROM, DVD, memory stick, or semiconductor storage device. Further, network adapters or interfaces 412 such as TCP/IP adapter cards, wireless Wi-Fi interface cards, or 3G or 4G wireless interface cards, or other wired or wireless communication links are also included in computing devices.

In one example embodiment, the smart-backup system 100 for a collaborative content-management platform may be stored in the tangible storage device 410 and may be downloaded from an external computer via a network (for example, the Internet, a local area network, or other, wide area network) and network adapter or interface 412.

Computing device 400 further includes device drivers 416 to interface with input and output devices. The input and output devices may include a computer display monitor 418, a keyboard 422, a keypad, a touch screen, a computer mouse 424, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or its uses. The broad teachings of the disclosure may be implemented in a variety of forms. Therefore, while this disclosure includes particular examples, the true scope of the disclosure should not be so limited since other modifications will become apparent upon a study of the drawings, and the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device's main body or a removable medium arranged so that it may be separated from the computer device's main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example, flash memory devices, erasable programmable read-only memory devices, or mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

We claim:

1. A smart-backup system for a collaborative content-management platform, the system comprising:
a memory storing one or more processor-executable routines; and
a processor communicatively coupled to the memory, the processor configured to execute the one or more processor-executable routines to:
retrieve properties corresponding to the content-management platform, wherein the platform comprises one or more associated subsites and cloud-containers, each of the cloud-containers having folders and associated files ;
list each of the one or more associated subsites and cloud-containers using a recursive traversal routine;
sort each of the listed subsites and cloud-containers based on a last modified time; and
perform an incremental backup of the platform based upon the last modified time.

2. The system of claim 1, wherein the processor is further configured to:
identify one or more modified cloud-containers based upon the last modified time; and
compare the last modified time of the identified cloud-containers with a corresponding previous backup time to perform the incremental backup of the platform.

3. The system of claim 2, wherein the processor is further configured to:
determine if the platform is due for reconciliation;
perform the incremental backup for the platform if it is determined that the platform is due for reconciliation; and
commit a backup snapshot of the platform if it is determined that the platform is not due for reconciliation.

4. The system of claim 1, wherein the reconciliation period is configurable by a user of the system.

5. The system of claim 4, wherein the reconciliation period is determined based upon a waiting period or changes in access control lists (ACLs).

6. The system of claim 4, wherein the reconciliation period further comprises a global reconciliation period used for backup all the cloud-based containers.

7. The system of claim 2, wherein the processor is further configured to:
identify one or more cloud-containers for incremental backup using change token APIs;
perform backup of content and settings of the identified cloud-containers; and
commit a backup snapshot for the backed up cloud-containers.

8. The system of claim 7, wherein the processor is further configured to:
acquire latest change token for one or more cloud-containers that have not changed; and
checkpoint the latest changed tokens for a subsequent backup cycle.

9. The system of claim 1, wherein the collaborative content-management platform comprises a cloud-based platform.

10. The system of claim 1, wherein the recursive traversal routine comprises a depth-first search (DFS).

11. The system of claim 1, wherein the memory is configured to store one or more of last modified time of subsites and cloud-containers, information regarding change token APIs and previous backup scans.

12. A smart-backup system for a collaborative content-management platform, the system comprising:
a memory storing one or more processor-executable routines; and
a processor communicatively coupled to the memory, the processor configured to execute the one or more processor-executable routines to:
access one or more associated subsites and cloud-containers of the platform to retrieve associated properties of each of the associated subsites and cloud-containers;
list each of the one or more associated subsites and cloud-containers using depth-first search (DFS);
compare a last modified time of the listed subsites and cloud-containers with the respective previous backup time to identify modified subsites; and
determine one or more modified cloud-containers using change token APIs; and
initiate backup of the one or modified cloud-containers.

13. The system of claim 12, wherein each of the cloud-containers comprises a plurality of folders and associated files.

14. The system of claim 12, wherein the processor is configured to perform an incremental backup of the platform based upon the last modified time.

15. The system of claim 12, wherein the processor is configured to retrieve associated properties of each of the associated subsites and cloud-containers from a storage.

16. The system of claim 12, wherein the processor is further configured to:
determine if the platform is due for reconciliation;
perform the incremental backup for the platform if it is determined that the platform is due for reconciliation; and
commit a backup snapshot of the platform if it is determined that the platform is not due for reconciliation.

17. A method of performing a backup of a content-management platform, the method comprising:
receiving a backup request for the content-management platform;
retrieving properties corresponding to one or more associated subsites and cloud-containers of the platform;
listing each of the one or more associated subsites and cloud-containers using a recursive traversal routine;
sorting each of the listed subsites and cloud-containers based on a last modified time; and
performing an incremental backup of the platform based upon the last modified time.

18. The method of claim 17, further comprising storing parameters corresponding to each of the listed subsites and cloud-containers.

19. The method of claim 18, further comprising storing one or more of last modified time of subsites and cloud-containers, information regarding change token APIs and previous backup scans.

20. The method of claim 17, further comprising repeating recursive traversal routine for each of the subsites and cloud-containers.
